(19) United States
(12) Patent Application Publication
(10) Pub. No.: US 2017/0349101 A1
(43) Pub. Date: Dec. 7, 2017

(54) VEHICLE DOOR MIRROR

(71) Applicant: KABUSHIKI KAISHA HONDA LOCK, MIYAZAKI-SHI, MIYAZAKI (JP)

(72) Inventor: Yasuyuki ETO, MIYAZAKI-SHI, MIYAZAKI (JP)

(73) Assignee: Kabushiki Kaisha Honda Lock, Miyazaki-shi, Miyazaki (JP)

(21) Appl. No.: 15/536,197

(22) PCT Filed: Dec. 14, 2015
(86) PCT No.: PCT/JP2015/084895

§ 371 Date: Jun. 15, 2017

(30) Foreign Application Priority Data
Dec. 19, 2014 (JP) 2014-257606

(51) Int. Cl. B60R 1/076; B60R 1/12

(52) U.S. Cl. CPC B60R 1/076; B60R 1/1207

(57) ABSTRACT

A vehicle door mirror in which a mirror housing is formed by joining a plurality of cover members to each other, is provided, wherein an engagement projection is projectingly provided integrally with one of a pair of cover members, the engagement projection projecting inward from an inner face of the one cover member and having a first engagement claw on an extremity part thereof and a second engagement claw disposed further toward the inner face side of the one cover member than the first engagement claw, and a first latching part and a second latching part are provided integrally with the other of the pair of cover members, the first engagement claw being resiliently engaged with the first latching part, and the second engagement claw being resiliently engaged with the second latching part. Such arrangement prevents the cover members from falling apart due to an external force or vibration.

### TECHNICAL FIELD

The present invention relates to a vehicle door mirror in which a mirror housing is formed by joining a plurality of cover members, made of a resin, to each other.

### BACKGROUND ART

An arrangement in which a mirror housing is formed by joining a plurality of cover members to each other, and an upper cover and a lower cover, which are a pair of cover members among the plurality of cover members, are joined to each other by means of resilient engagement of an engagement claw is already known from Patent Document 1.

### RELATED ART DOCUMENTS

### Patent Documents

Patent Document 1: Japanese Patent Application Laid-open No. 2006-182286

### SUMMARY OF THE INVENTION

### Problems to be Solved by the Invention

However, in the arrangement disclosed in Patent Document 1 above, when the mirror housing is subjected to an external force or vibration, the engagement claw flexes in the engagement release direction, and there is a possibility that the resilient engagement will be released.

The present invention has been accomplished in light of such circumstances, and it is an object thereof to provide a vehicle door mirror that can prevent cover members forming a mirror housing from coming apart from each other due to an external force or vibration.

### Means for Solving the Problems

In order to attain the above object, according to a first aspect of the present invention, there is provided a vehicle door mirror in which a mirror housing is formed by joining a plurality of cover members, made of a resin, to each other, characterized in that an engagement projection is projectingly provided integrally with one of a pair of cover members among the plurality of cover members, the engagement projection projecting inward from an inner face of the one cover member and having a first engagement claw on an extremity part thereof and a second engagement claw disposed further toward the inner face side of the one cover member than the first engagement claw, and a first latching part and a second latching part are provided integrally with the other of the pair of cover members, the first engagement claw being resiliently engaged with the first latching part, and the second engagement claw being resiliently engaged with the second latching part.

Further, according to a second aspect of the present invention, in addition to the first aspect, the second engagement claw is disposed at a position offset from the first engagement claw in a direction orthogonal to a flexing direction of the engagement projection and a projecting direction of the engagement projection from the one cover member.

Moreover, according to a third aspect of the present invention, in addition to the first or second aspect, the second engagement claw is formed integrally with the engagement projection so as to be spaced from the inner face of the one cover member.

### Effects of the Invention

In accordance with the first aspect of the present invention, even when an external force or vibration causes the engagement projection to flex toward the side on which resilient engagement of the first engagement claw on the extremity part is released, since the amount of flexure on the base end part side of the engagement projection is smaller than the amount of flexure of the extremity part, it is possible to prevent the resilient engagement of the second engagement claw, which is closer to the base end part of the engagement projection than the first engagement claw, from being released, thereby preventing the cover members from coming apart from each other due to the external force or vibration.

Furthermore, in accordance with the second aspect of the present invention, since the second engagement claw is disposed at a position offset from the first engagement claw in the direction orthogonal to the flexing direction of the engagement projection and the projecting direction of the engagement projection from one cover member, it is possible to simplify the structure of the first and second latching parts, with which the first and second engagement claws are engaged, thereby simplifying the structure of a die for molding the other of the cover members.

Moreover, in accordance with the third aspect of the present invention, due to the second engagement claw being spaced from the inner face of one of the cover members, it is possible to prevent a sink mark from occurring on the outer surface of the one cover member due to the presence of the second engagement claw.

### BRIEF DESCRIPTION OF DRAWINGS

FIG. 1 is a perspective view of a vehicle door mirror at a raised position when viewed obliquely from the rear. (first embodiment)

FIG. 2 is a perspective view of the vehicle door mirror at the raised position when viewed obliquely from the front. (first embodiment)

FIG. 3 is an exploded perspective view of a lower cover and an upper cover. (first embodiment)

FIG. 4 is a perspective view showing a state in which first and second engagement claws of the upper cover resiliently engage with first and second latching parts of the lower cover. (first embodiment)

FIG. 5 is a sectional view along line 5-5 in FIG. 4. (first embodiment)

FIG. 6 is a view of part of the upper cover from the direction of arrow 6 in FIG. 5. (first embodiment)

### EXPLANATION OF REFERENCE NUMERALS AND SYMBOLS

11 Door mirror
12 Mirror housing
13 Housing main body, which is a cover member
14 Lower cover, which is a cover member
15 Upper cover, which is a cover member
34 Engagement projection
35 First engagement claw
36 Second engagement claw
37 First latching part
38 Second latching part
46 Flexing direction
47 Projecting direction

### MODES FOR CARRYING OUT THE INVENTION

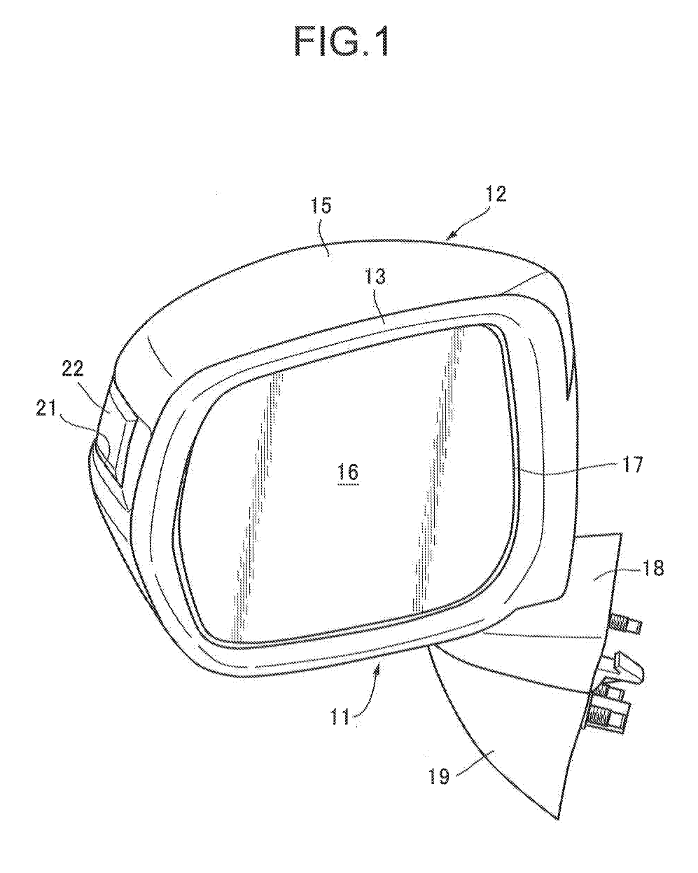

An embodiment of the present invention is explained below by reference to FIG. 1 to FIG. 6.

### First Embodiment

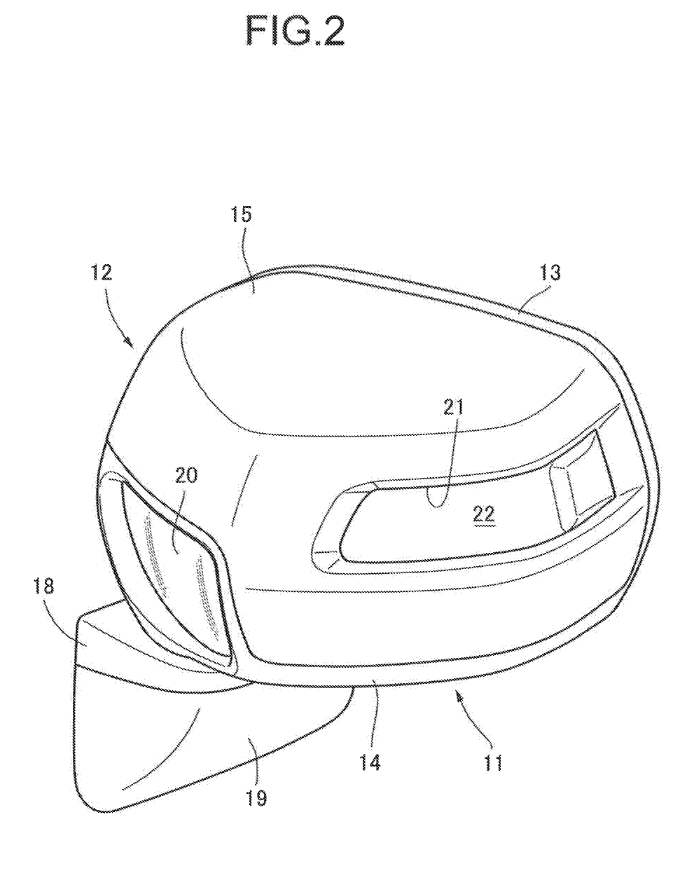

First, in FIG. 1 and FIG. 2, a mirror housing 12 of a door mirror 11 retractably supported on a side door on the passenger seat side of a four wheel passenger vehicle is formed by joining a plurality of cover members, made of a resin, to each other, and in this embodiment the mirror housing 12 is formed from a housing main body 13 as a first cover member having a mirror housing recess 17 in which a mirror 16 is housed, a lower cover 14 as a second cover member covering a lower part of the housing main body 13 from below, and an upper cover 15 as a third cover member covering the housing main body 13 from the opposite direction to the mirror 16.

The housing main body 13 is supported on a base member 18 mounted on the side door, and a base cover 19 covering a lower part of the base member 18 is mounted on the lower part of the base member 18. Moreover, the mirror housing 12 pivots between a raised position at which it projects sideways from the side door and a retracted position at which it is retracted to the side door side.

Mounted on the lower cover 14 is a vision assistance mirror 20, the vision assistance mirror 20 facing forward when the mirror housing 12 is at the raised position. This vision assistance mirror 20 is for viewing the side of the vehicle in front of the side door on the passenger seat side, the driver being able to view the side of the vehicle in front of the side door on the passenger seat side by means of a mirror disposed in a front part within a vehicle compartment and the vision assistance mirror 20.

Furthermore, provided in the upper cover 15 is an opening 21 that opens toward the side and the rear when the mirror housing 12 is at the raised position, a side turn lamp 22 facing the opening 21 being mounted on an inner face of the upper cover 15.

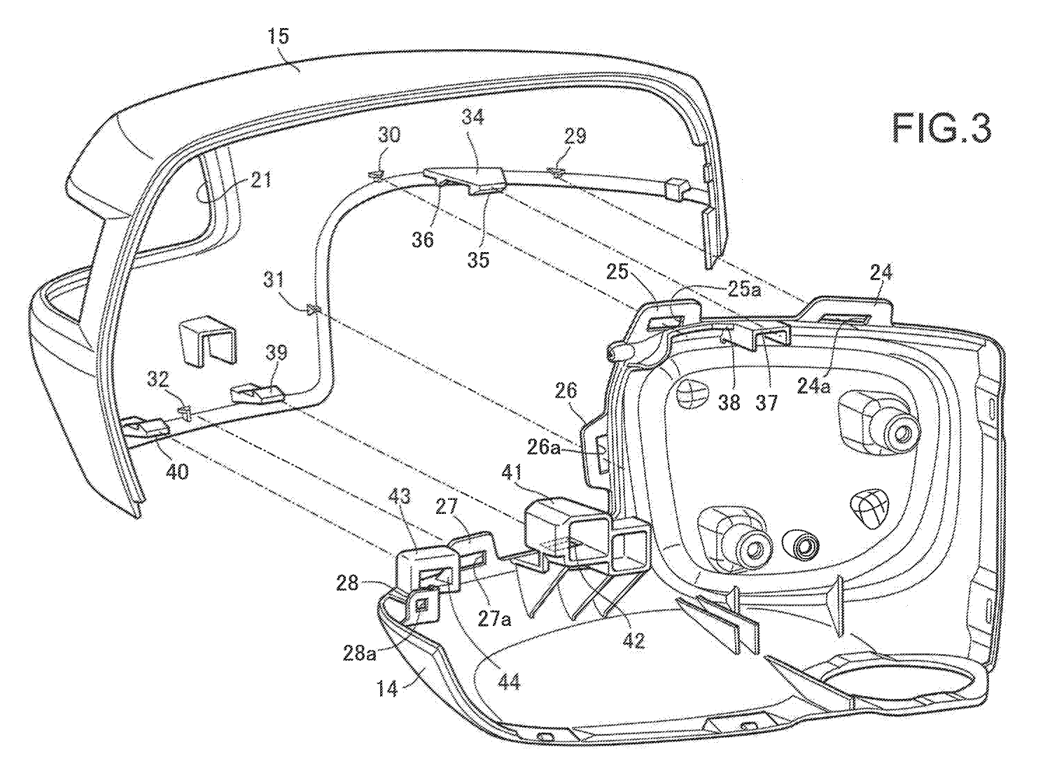

In FIG. 3, projectingly provided integrally with an upper part of the lower cover 14 so as to overlap an inner face of a lower part of the upper cover 15 are first, second, third, fourth, and fifth positioning parts 24, 25, 26, 27, and 28 spaced in sequence from the base member 18 side while each forming rectangular positioning holes 24a, 25a, 26a, 27a, and 28a. On the other hand, projectingly provided integrally with the inner face of the lower part of the upper cover 15 are first, second, third, and fourth positioning projections 29, 30, 31, and 32 so as to be inserted into the positioning holes 24a to 27a of the first to fourth positioning parts 24 to 27, and a fifth positioning projection (not illustrated) so as to be inserted into the positioning hole 28a of the fifth positioning part 28.

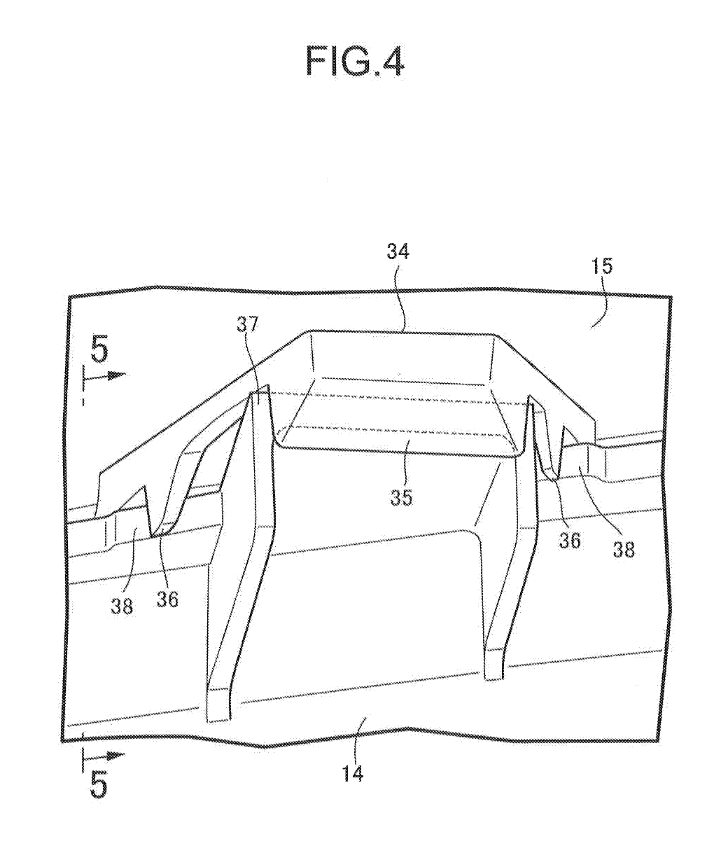

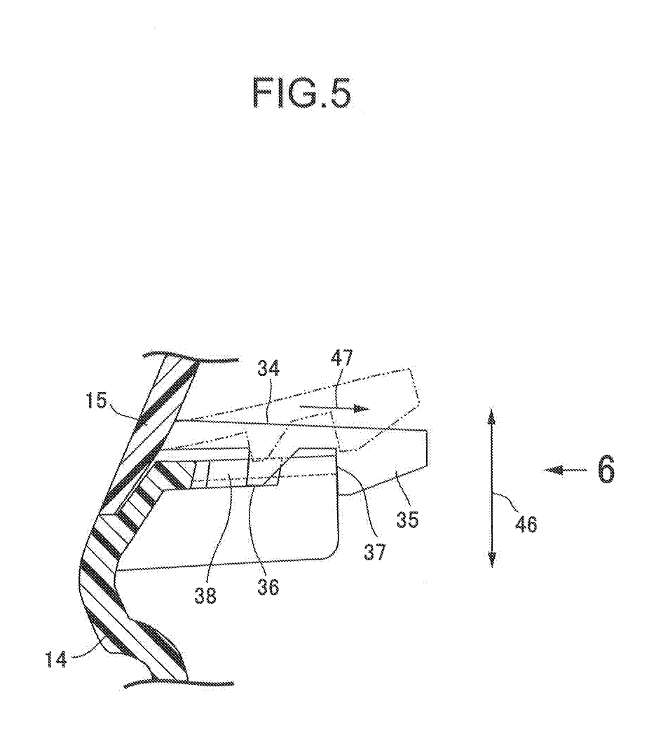

Referring in addition to FIG. 4 and FIG. 5, a pair of cover members among the plurality of cover members forming the mirror housing 12 are joined to each other in accordance with the present invention, and in this embodiment among the housing main body 13, the lower cover 14 and the upper cover 15, which form the mirror housing 12, the lower cover 14 and the upper cover 15 are joined in accordance with the present invention.

Projectingly provided integrally with the upper cover 15, which is one of the lower cover 14 and the upper cover 15, is an engagement projection 34 projecting inward from the inner face of the upper cover 15 so as to have a first engagement claw 35 on the extremity part thereof and a pair of second engagement claws 36 disposed further toward the inner face side of the upper cover 15 than the first engagement claw 35, and provided integrally with the lower cover 14, which is the other of the lower cover 14 and the upper cover 15, are a first latching part 37 with which the first engagement claw 35 is resiliently engaged and a pair of second latching parts 38 with which the second engagement claws 36 are resiliently engaged.

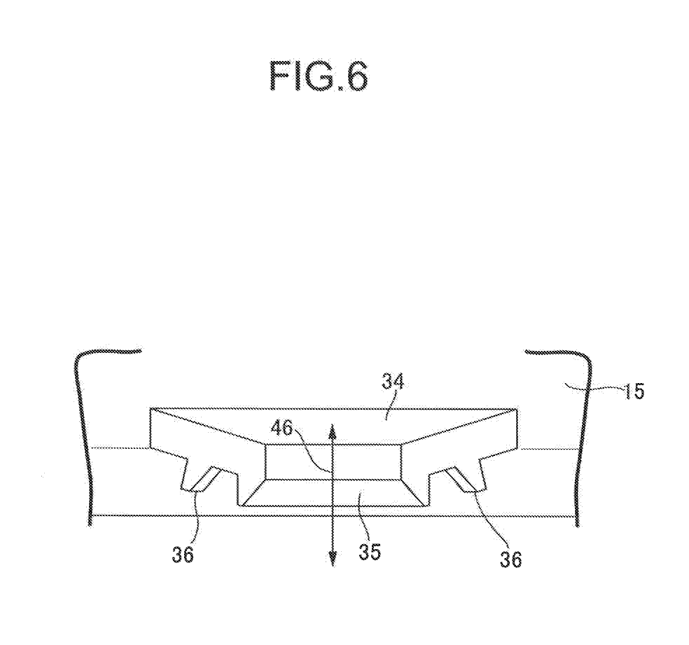

Referring in addition to FIG. 6, the engagement projection 34 is formed into a trapezoidal shape in which its width narrows in going toward the extremity while it projects inward from the inner face of the lower part of the upper cover 15 so as to be disposed between the first and second positioning projections 29 and 30, the first engagement claw 35 is formed so as to bend downward through right angles from the extremity of the engagement projection 34, and the second engagement claws 36 are formed so as to project downward from opposite sides of the engagement projection 34 further toward the inner face side of the upper cover 15 than the first engagement claw 35.

On the other hand, the first latching part 37 is projectingly provided integrally with an inner face of the upper part of the lower cover 14 while having a substantially U-shaped cross-sectional shape opening downward, and the first engagement claw 35 can resiliently engage with a projecting end of the first latching part 37. The second latching parts 38 are projectingly provided integrally with the inner face of the upper part of the lower cover 14 so as to extend toward opposite sides from the base end part of the first latching part 37.

The engagement projection 34 can flex in the vertical direction when it engages with the first latching part 37 and when the engagement with the first latching part 37 is released, and since the second engagement claws 36 are formed integrally with opposite sides of the engagement projection 34, which has a trapezoidal shape whose width narrows in going toward the extremity, so as to be disposed further toward the inner face side of the upper cover 15 than the first engagement claw 35, the second engagement claws 36 are disposed at a position offset from the first engagement claw 35 in a direction orthogonal to a flexing direction 46 of the engagement projection 34 and a projecting direction 47 of the engagement projection 34 from the upper cover 15.

Moreover, the second engagement claw 36 is formed integrally with the engagement projection 34 so as to be spaced from the inner face of the upper cover 15.

Referring again to FIG. 3, projectingly provided integrally with the inner face of the lower part of the upper cover 15 so as to project inward are a third engagement claw 39 disposed between the third positioning projection 31 and the fourth positioning projection 32, and a fourth engagement claw 40 disposed at a position such that it sandwiches the fourth positioning projection 32 between itself and the third engagement claw 39.

On the other hand, projectingly provided integrally with the inner face of the upper part of the lower cover 14 are a third latching part 41 having an engagement hole 42 with which the third engagement claw 39 is resilient engaged and a fourth latching part 43 having an engagement hole 44 with which the fourth engagement claw 40 is resilient engaged.

Peripheral edges of the lower cover 14 and the upper cover 15, which are joined to each other, are resiliently engaged with the peripheral edge of the housing main body 13, thereby forming the mirror housing 12.

A door mirror of a side door on the driver's seat side is formed in basically the same way as for the door mirror 11 described above except that the vision assistance mirror 20 is not provided.

The operation of this embodiment is now explained. The engagement projection 34 projecting inward from the inner face of the upper cover 15 is projectingly provided integrally with the upper cover 15, which is one of the lower cover 14 and the upper cover 15 among the housing main body 13, the lower cover 14, and the upper cover 15 forming the mirror housing 12. The engagement projection 34 has the first engagement claw 35 on the extremity part thereof and the pair of second engagement claws 36 disposed further toward the inner face side of the upper cover 15 than the first engagement claw 35. The first latching part 37, with which the first engagement claw 35 is resiliently engaged, and the second latching parts 38, with which the second engagement claws 36 are resiliently engaged, are provided integrally with the lower cover 14, which is the other of the lower cover 14 and the upper cover 15. Therefore, even if, due to an external force or vibration, the engagement projection 34 flexes toward the side on which resilient engagement of its extremity part with the first engagement claw 35 is released, as shown by the chain line in FIG. 5, since the amount of flexure on the base end part side of the engagement projection 34 is less than the amount of flexure of the extremity part, it is possible, by preventing the resilient engagement with the second latching part 38 of the second engagement claw 36, which is closer to the base end part of the engagement projection 34 than the first engagement claw 35, from being released, to prevent the lower cover 14 and the upper cover 15 from coming apart from each other due to external force or vibration.

Furthermore, since the second engagement claws 36 are disposed at positions that are offset from the first engagement claw 35 in the direction orthogonal to the flexing direction 46 of the engagement projection 34 and the projecting direction 47 of the engagement projection 34 from the upper cover 15, it is possible to simplify the structure of the first and second latching parts 37 and 38, with which the first and second engagement claws 35 and 36 are engaged, thereby simplifying the structure of a die for molding the lower cover 14.

Moreover, since the second engagement claw 36 is formed integrally with the engagement projection 34 so as to be spaced from the inner face of the upper cover 15, it is possible to prevent a sink mark from occurring on an outer surface of the upper cover 16 due to the presence of the second engagement claw 36.

An embodiment of the present invention is explained above, but the present invention is not limited to the above embodiment and may be modified in a variety of ways as long as the modifications do not depart from the spirit and scope thereof.

For example, in the above embodiment a case in which the present invention is applied to a structure via which the lower cover 14 and the upper cover 15 are joined is explained, but the present invention may be applied to a structure via which the housing main body 13 and the lower cover 14 are joined or a structure via which the housing main body 13 and the upper cover 15 are joined.

1. A vehicle door mirror in which a mirror housing is formed by joining a plurality of cover members, made of a resin, to each other, wherein an engagement projection is projectingly provided integrally with one of a pair of cover members among the plurality of cover members, the engagement projection projecting inward from an inner face of said one cover member and having a first engagement claw on an extremity part thereof and a second engagement claw disposed further toward the inner face side of said one cover member than the first engagement claw, and a first latching part and a second latching part are provided integrally with the other of the pair of cover members, the first engagement claw being resiliently engaged with the first latching part, and the second engagement claw being resiliently engaged with the second latching part.

2. The vehicle door mirror according to claim 1, wherein the second engagement claw is disposed at a position offset from the first engagement claw in a direction orthogonal to a flexing direction of the engagement projection and a projecting direction of the engagement projection from said one cover member.

3. The vehicle door mirror according to claim 1, wherein the second engagement claw is formed integrally with the engagement projection so as to be spaced from the inner face of said one cover member.

4. The vehicle door mirror according to claim 2, wherein the second engagement claw is formed integrally with the engagement projection so as to be spaced from the inner face of said one cover member.
